(19) United States
(12) Patent Application Publication
(10) Pub. No.: US 2026/0088201 A1
(43) Pub. Date: Mar. 26, 2026

(54) PREPARATION METHOD FOR IRON-NICKEL MAGNETIC POWDER CORE MATERIAL

(71) Applicant: HENGDIAN GROUP DMEGC MAGNETICS CO., LTD, Dongyang Jinhua, Zhejiang (CN)

(72) Inventors: Xudong JIN, Dongyang Jinhua, Zhejiang (CN); Bin GUO, Dongyang Jinhua, Zhejiang (CN)

(21) Appl. No.: 19/112,570

(22) PCT Filed: Sep. 12, 2023
(86) PCT No.: PCT/CN2023/118150

§ 371 Date: Mar. 17, 2025

(30) Foreign Application Priority Data
Sep. 21, 2022 (CN) 202211150265.0

(51) Int. Cl. H01F 1/147; B22F 1/05; B22F 1/142; B22F 1/16

(52) U.S. Cl. CPC H01F 1/1475; B22F 1/05; B22F 1/142; B22F 1/16; B22F 2301/35; B22F 2304/10; B22F 2998/10

(57) ABSTRACT

Disclosed in the present application is a preparation method for an iron-nickel magnetic powder core material. The preparation method comprises the following steps: (1) mixing iron-nickel powder and an organic coating agent to perform primary coating treatment, and then successively performing drying and annealing to obtain primary passivated iron-nickel powder; and (2) mixing the primary passivated iron-nickel powder obtained in step (1) and an aqueous solution of an inorganic coating agent to perform secondary coating treatment, and then drying same to obtain secondary passivated iron-nickel powder; and (3) mixing the secondary passivated iron-nickel powder obtained in step (2) and a binder, and then successively performing granulation, baking and pressing to obtain an iron-nickel magnetic powder core material. The preparation method provided by the present application can achieve an excellent coating effect on the surfaces of iron-nickel powder and achieve a stable coating layer structure, and can effectively reduce the introduction of carbon, thus further improving the inductance and saturation characteristics of the iron-nickel magnetic powder core material.

### TECHNICAL FIELD

Embodiments of the present application relate to the technical field of metal soft magnetic materials, such as a preparation method for an iron-nickel magnetic powder core material.

### BACKGROUND

Metal magnetic powder core refers to a soft magnetic material product with a certain shape and size formed by the process that metal or magnetic powder core magnetic powder is subjected to passivation coating, then added with an insulating bonding substance and pressed with a certain pressure. Because the metal magnetic particles are small and have a large surface area, and an insulating layer is formed on the surface of the magnetic particles by passivation coating, the magnetic powder core has a higher resistivity and a better high-frequency characteristic.

Iron-nickel magnetic powder core is widely used in telecommunication, computers or control systems because of its high energy storage capacity, high saturation flux density, and relatively-low loss per unit volume of the core. One of the main factors affecting the performance of iron-nickel magnetic powder core is the insulating material coating, i.e., the compact passivation layer formed on the surface of metal powder by passivation. The passivation mechanism is that the passivator and powder particles are chemically reacted to produce a uniform passivation film on the surface of the metal particles, and thereby eddy currents formed in powder particles can be effectively isolated and the eddy current loss of the magnetic core is reduced. Currently, there are various passivators used for magnetic core preparation, mainly including strong acids, such as nitric acid, phosphoric acid, or chromic acid. In the conventional coating process, an acetone solution of phosphoric acid is used to phosphatize the metal particles, and then added with a high-temperature glue. Firstly, although the method can enhance the saturation characteristic by regulating the ratio of phosphoric acid to glue, magnetic permeability will decrease; secondly, phosphoric acid is easy to react with iron to reduce the particles of iron powder so as to decrease the magnetic permeability; moreover, the use of the organic solvent such as acetone increases the carbon content of the magnetic powder core material, and hinders the enhancement of saturation characteristic. Therefore, the coating process of the insulating material is a key process in the preparation of magnetic powder cores.

CN112635189A discloses a production method for an iron-nickel magnetic powder core with a high finished product rate, in which water-atomized iron-nickel powder is mixed with air-atomized iron-nickel powder, then added with a phosphoric acid coating agent diluted with alcohol or acetone and subjected to passivation, and then added with a lubricant and pressed to obtain an iron-nickel magnetic powder core. In this method, in one hand, the phosphoric acid insulator used is easy to react with iron to reduce the particles of iron powder, thus causing a decrease in the magnetic permeability; in another hand, the use of the organic diluent increases the carbon content of the magnetic powder core, hindering the enhancement of the saturation characteristic.

CN102306530A discloses an iron-nickel alloy soft magnetic material with a magnetic permeability p of 60 and a manufacturing method thereof. In this method, the iron-nickel powder is subjected to surface treatment with phosphoric acid, wherein the addition amount of phosphoric acid is 2.0-2.5% of the mass of the iron-nickel alloy powder, and then added with the phenolic resin, dried, and pressed to obtain the iron-nickel alloy soft magnetic material. This method also employs phosphoric acid coating agent, which is not conducive to enhancing the magnetic permeability of the soft magnetic material.

Therefore, it is of great significance to provide a preparation method that can effectively enhance the magnetic properties of iron-nickel magnetic powder core materials.

### SUMMARY

The following is a summary of subject matter that is described in detail herein. This summary is not intended to be limiting as to the scope of the claims.

In view of the above problems, embodiments of the present application provide a preparation method for an iron-nickel magnetic powder core material. Compared with the related art, the preparation method for the iron-nickel magnetic powder core material provided in the present application can effectively improve the inductance of the iron-nickel magnetic powder core material and at the same time ensure that the saturation characteristic is further improved.

Embodiments of the present application provide a preparation method for an iron-nickel magnetic powder core material, and the preparation method comprises the following steps:
(1) mixing iron-nickel powder and an organic coating agent for a primary coating treatment, and then sequentially performing drying and annealing to obtain primary passivated iron-nickel powder;
(2) mixing the primary passivated iron-nickel powder obtained in step (1) and an aqueous solution of an inorganic coating agent for a secondary coating treatment, and then drying to obtain secondary passivated iron-nickel powder; and
(3) mixing the secondary passivated iron-nickel powder obtained in step (2) and a binder, and then sequentially performing granulation, baking, and pressing to obtain the iron-nickel magnetic powder core material.

In the preparation method provided in the present application, an insulating layer can be formed on the surface of the magnetic particles through cooperation between the primary coating treatment and the secondary coating treatment, so that the resistivity of the magnetic powder core is higher. In one aspect, the primary coating treatment is performed by the organic coating agent, and then drying and annealing are performed to form an organic coating layer; in another aspect, the secondary coating treatment is performed by a water-soluble inorganic coating agent, which further enhances the coating effect and avoids the damage of coating layer caused by overly thin thickness in subsequent processes. The coating agent in the second coating treatment provided in the present application adopts a water-soluble formula to reduce the introduction of carbon content and avoid reacting with the iron powder, thereby avoiding a decrease in the magnetic permeability of the magnetic powder core material and improving the saturation characteristic and inductance of the magnetic powder core material.

Preferably, a particle size of the iron-nickel powder in step (1) is 25-38 μm, which may be, for example, 25 μm, 26 μm, 27 μm, 28 μm, 29 μm, 30 μm, 31 μm, 32 μm, 34 μm, 36 μm, or 38 μm; however, the particle size is not limited to the listed values, and other unlisted values within the numerical range are also applicable.

In the present application, the particle size of the iron-nickel powder is preferably controlled to be in a specific range, which can further enhance the magnetic properties of the magnetic powder core material.

Preferably, a mass percentage of nickel in the iron-nickel powder is 49-51%, which may be, for example, 49%, 49.5%, 50%, 50.5%, or 51%; however, the mass percentage is not limited to the listed values, and other unlisted values within the numerical range are also applicable.

Preferably, the organic coating agent comprises any one or a combination of at least two of an organosilicon resin, a silane coupling agent or a phenolic resin, wherein typical but not-limiting combinations comprise a combination of an organosilicon resin and a silane coupling agent, or a combination of a silane coupling agent and a phenolic resin.

Preferably, an addition amount of the organic coating agent is 0.3-0.5% of a mass of the iron-nickel powder, which may be, for example, 0.3%, 0.32%, 0.35%, 0.38%, 0.4%, 0.42%, 0.45%, 0.48%, or 0.5%; however, the addition amount is not limited to the listed values, and other unlisted values within the numerical range are also applicable.

Preferably, the mixing in step (1) is performed with stirring.

Preferably, the annealing in step (1) is performed at a temperature of 880-920° C., which may be, for example, 880° C., 885° C., 890° C., 895° C., 900° C., 905° C., 910° C., 915° C., or 920° C.; however, the temperature is not limited to the listed values, and other unlisted values within the numerical range are also applicable.

Preferably, the inorganic coating agent in step (2) comprises any one or a combination of at least two of aluminum phosphate, glass powder or potassium silicate, wherein typical but non-limiting combinations comprise a combination of aluminum phosphate and glass powder, or a combination of glass powder and potassium silicate.

In the present application, instead of a mixed coating agent of phosphoric acid and propanol, the water-soluble coating agent is used as the preferred coating agent, which, in one aspect, can reduce the carbon content and thus enhance the saturation characteristic of the magnetic powder core, and in another aspect, can avoid the reaction between phosphoric acid and iron, which reduces the iron powder particles and the magnetic permeability, thus enhancing the magnetic properties.

Preferably, an addition amount of the inorganic coating agent is 0.1-0.5% of a mass of the primary passivated iron-nickel powder, which may be, for example, 0.1%, 0.15%, 0.2%, 0.25%, 0.3%, 0.35%, 0.4%, 0.45%, or 0.5%; however, the addition amount is not limited to the listed values, and other unlisted values within the numerical range are also applicable.

Preferably, the mixing in step (2) is performed with stirring.

Preferably, after the drying in step (2), sieving is performed to obtain the secondary passivated iron-nickel powder.

Preferably, the secondary passivated iron-nickel powder obtained by the sieving in step (2) has a particle size of 120-150 μm, which may be, for example, 120 μm, 122 μm, 125 μm, 128 μm, 130 μm, 132 μm, 135 μm, 138 μm, 140 μm, 142 μm, 145 μm, 148 μm, or 150 μm; however, the particle size is not limited to the listed values, and other unlisted values within the numerical range are also applicable.

Preferably, the binder in step (3) comprises any one or a combination of at least two of a specialty silane monomer, silica sol, a silane coupling agent or polyvinyl butyral, wherein typical but non-limiting combinations comprise a combination of a specialty silane monomer and silica sol.

In the present application, the binder is preferably controlled to comprise any one or a combination of at least two of a specialty silane monomer, silica sol, a silane coupling agent or polyvinyl butyral, which can effectively enhance bond strength of grain boundary and compactness, and enhance the magnetic properties of the magnetic powder core material and the insulating properties as well.

Preferably, an addition amount of the binder is 0.1-2% of a mass of the secondary passivated iron-nickel powder, which may be, for example, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, or 2%; however, the addition amount is not limited to the listed values, and other unlisted values within the numerical range are also applicable.

Preferably, the mixing in step (3) is performed with stirring.

In the present application, the mixing in step (3) is performed with stirring to obtain a mixture of the secondary passivated iron-nickel powder and the binder, and the stirring is accompanied by the evaporation of the solvent, and the stirring is performed until a content of the solvent is about 0.6-0.8%.

Preferably, after the granulation in step (3), a particle size is 250-270 μm, which may be, for example, 250 μm, 252 μm, 255 μm, 258 μm, 260 μm, 262 μm, 264 μm, 265 μm, 268 μm, or 270 μm; however, the particle size is not limited to the listed values, and other unlisted values within the numerical range are also applicable.

Preferably, the baking is performed at a temperature of 150-170° C., which may be, for example, 150° C., 152° C., 154° C., 156° C., 158° C., 160° C., 162° C., 164° C., 166° C., 168° C., or 170° C.; however, the temperature is not limited to the listed values, and other unlisted values within the numerical range are also applicable.

Preferably, the baking is performed for a period of 80-100 min, which may be, for example, 80 min, 82 min, 85 min, 88 min, 90 min, 92 min, 95 min, 98 min, or 100 min; however, the period is not limited to the listed values, and other unlisted values within the numerical range are also applicable.

Preferably, after the baking in step (3), a lubricant is added, then sieving is performed, and then the pressing is performed.

Preferably, the lubricant comprises any one or a combination of at least two of polypentaerythritol, polyethylene wax, magnesium stearate, hydrous magnesium silicate or a polyester resin, wherein typical but non-limiting combinations comprise a combination of polypentaerythritol and polyethylene wax, or a combination of magnesium stearate and hydrous magnesium silicate.

Preferably, an addition amount of the lubricant is 0.2-0.5% of a mass of the secondary passivated iron powder, which may be, for example, 0.2%, 0.25%, 0.3%, 0.35%, 0.4%, 0.45%, or 0.5%; however, the addition amount is not limited to the listed values, and other unlisted values within the numerical range are also applicable.

Preferably, after the sieving in step (3), a particle size is 250-270 μm, which may be, for example, 250 μm, 252 μm, 255 μm, 258 μm, 260 μm, 262 μm, 264 μm, 265 μm, 268 μm, or 270 μm; however, the particle size is not limited to the listed values, and other unlisted values within the numerical range are also applicable.

Preferably, a pressure of the pressing in step (3) is 17-20 T/cm², which may be, for example, 17 T/cm², 17.5 T/cm², 18 T/cm², 18.5 T/cm², 19 T/cm², 19.5 T/cm², or 20 T/cm²; however, the pressure is not limited to the listed values, and other unlisted values within the numerical range are also applicable.

As a preferred technical solution of the present application, the preparation method comprises the following steps:
(1) mixing and stirring iron-nickel powder with a particle size of 25-38 μm and an organic coating agent for a primary coating treatment, and then performing drying, and annealing at 880-920° C. to obtain primary passivated iron-nickel powder;
an addition amount of the organic coating agent is 0.3-0.5% of a mass of the iron-nickel powder, and the organic coating agent comprises any one or a combination of at least two of an organosilicon resin, a silane coupling agent or a phenolic resin;
(2) mixing and stirring the primary passivated iron-nickel powder obtained in step (1) and an aqueous solution of an inorganic coating agent for a secondary coating treatment, and then sequentially drying and sieving to obtain secondary passivated iron-nickel powder with a particle size of 120-150 μm;
an addition amount of the inorganic coating agent is 0.1-0.5% of a mass of the primary passivated iron-nickel powder, and the inorganic coating agent comprises any one or a combination of at least two of aluminum phosphate, glass powder or potassium silicate; and
(3) mixing and stirring the secondary passivated iron-nickel powder obtained in step (2) and a binder, and then performing granulation, wherein a particle size after the granulation is 250-270 μm, and then baking at 150-170° C. for 80-100 min, then adding a lubricant, and then sieving, wherein a particle size after the sieving is 250-270 μm, and then pressing at 17-20 T/cm² to obtain the iron-nickel magnetic powder core material;
an addition amount of the binder is 0.1-2% of a mass of the secondary passivated iron-nickel powder, and the binder comprises any one or a combination of at least two of a specialty silane monomer, silica sol, a silane coupling agent or polyvinyl butyral; an addition amount of the lubricant is 0.2-0.5% of a mass of the secondary passivated iron powder, and the lubricant comprises any one or a combination of at least two of polypentaerythritol, polyethylene wax, magnesium stearate, hydrous magnesium silicate or a polyester resin.

Compared to the related art, the present application has the following beneficial effects.
(1) The preparation method provided by the present application can achieve an excellent coating effect on the surface of iron-nickel powder, the coating layer has a stable structure, the introduction of carbon can be effectively reduced, and the inductance and saturation characteristic of the iron-nickel magnetic powder core material can be further improved. The obtained iron-nickel magnetic powder core material has L0≥42.37 μH, L3.3≥38.69 μH, L5.1≥34.01 μH, L6.9≥28.73 μH, and L8.7≥23.63 μH under preferred conditions; the ratio of inductance to L0 decays slowly under different currents, and under preferred conditions, the saturation characteristic is ≥91.16% at 3.3 A, the saturation characteristic is ≥79.96% at 5.1 A, the saturation characteristic is ≥67.61% at 6.9 A, and the saturation characteristic is ≥55.46% at 8.7 A.
(2) The preparation method provided by the embodiments of the present application can effectively enhance the bond strength of grain boundary and compactness, and further enhance the magnetic properties of the magnetic powder core material and the insulating properties as well.

Other aspects will be appreciated upon reading and understanding the detailed description.

### DETAILED DESCRIPTION

The technical solutions of the present application are further described below via specific embodiments. It should be understood by those skilled in the art that the embodiments merely aid in the understanding of the present application and should not be regarded as a specific limitation of the present application.

### Example 1

This example provides a preparation method for an iron-nickel magnetic powder core material, and the preparation method comprises the following steps:
(1) iron-nickel powder with a particle size of 25-38 μm (a mass percentage of nickel was 50%) and an organosilicon resin (methyl polysiloxane resin, model SH-9502) were mixed and stirred for a primary coating treatment, and then sequentially dried, and annealed at 900° C. to obtain primary passivated iron-nickel powder;
an addition amount of the organosilicon resin was 0.4% of a mass of the iron-nickel powder;
(2) the primary passivated iron-nickel powder obtained in step (1) and an aqueous solution of potassium silicate were mixed and stirred for a secondary coating treatment, and then dried and sieved sequentially to obtain secondary passivated iron-nickel powder with a particle size of 120-150 μm;
an addition amount of the potassium silicate was 0.3% of a mass of the primary passivated iron-nickel powder; and
(3) the secondary passivated iron-nickel powder obtained in step (2) and methyl chlorosilane were mixed and stirred, and then subjected to granulation where a particle size was 250-270 μm after the granulation, and then baked at 160° C. for 90 min, then added with magnesium stearate, and then subjected to sieving where a particle size was 250-270 μm after the sieving, and pressed at 19 T/cm² to obtain the iron-nickel magnetic powder core material;
an addition amount of the methyl chlorosilane was 1% of a mass of the secondary passivated iron-nickel powder; an addition amount of the magnesium stearate is 0.3% of a mass of the secondary passivated iron powder.

### Example 2

This example provides a preparation method for an iron-nickel magnetic powder core material, and the preparation method comprises the following steps:
(1) iron-nickel powder with a particle size of 25-38 μm (a mass percentage of nickel was 49%) and a silane coupling agent (model KH550) were mixed and stirred for a primary coating treatment, and then sequentially dried, and annealed at 880° C. to obtain primary passivated iron-nickel powder;
an addition amount of the silane coupling agent was 0.3% of a mass of the iron-nickel powder;
(2) the primary passivated iron-nickel powder obtained in step (1) and an aqueous solution of aluminum phosphate were mixed and stirred for a secondary coating treatment, and then dried and sieved sequentially to obtain secondary passivated iron-nickel powder with a particle size of 120-150 μm;
an addition amount of the aluminum phosphate was 0.5% of a mass of the primary passivated iron-nickel powder; and
(3) the secondary passivated iron-nickel powder obtained in step (2) and a silane coupling agent (model KH550) were mixed and stirred, and then subjected to granulation where a particle size was 250-270 μm after the granulation, and then baked at 150° C. for 100 min, then added with polyethylene wax (with a molecular mass of 2000), and then subjected to sieving where a particle size was 250-270 μm after the sieving, and pressed at 20 T/cm² to obtain the iron-nickel magnetic powder core material;
an addition amount of the silane coupling agent in step (3) was 0.1% of a mass of the secondary passivated iron-nickel powder; an addition amount of the polyethylene wax was 0.5% of a mass of the secondary passivated iron powder.

### Example 3

This example provides a preparation method for an iron-nickel magnetic powder core material, and the preparation method comprises the following steps:
(1) iron-nickel powder with a particle size of 25-38 μm (a mass percentage of nickel was 51%) and a phenolic resin (model 2402) were mixed and stirred for a primary coating treatment, and then dried, and annealed at 920° C. to obtain primary passivated iron-nickel powder;
an addition amount of the phenolic resin was 0.5% of a mass of the iron-nickel powder;
(2) the primary passivated iron-nickel powder obtained in step (1) and an aqueous solution of glass powder were mixed and stirred for a secondary coating treatment, and then dried and sieved sequentially to obtain secondary passivated iron-nickel powder with a particle size of 120-150 μm;
an addition amount of the glass powder was 0.1% of a mass of the primary passivated iron-nickel powder; and
(3) the secondary passivated iron-nickel powder obtained in step (2) and methyl chlorosilane were mixed and stirred, and then subjected to granulation where a particle size was 250-270 μm after the granulation, and then baked at 170° C. for 80 min, then added with polyethylene wax (with a molecular mass of 2000), and then subjected to sieving where a particle size was 250-270 μm after the sieving, and pressed at 17 T/cm² to obtain the iron-nickel magnetic powder core material;
an addition amount of the methyl chlorosilane in step (3) was 2% of a mass of the secondary passivated iron-nickel powder; an addition amount of the polyethylene wax was 0.2% of a mass of the secondary passivated iron powder.

### Example 4

This example provides a preparation method for an iron-nickel magnetic powder core material, which differs from Example 1 only in that the potassium silicate was replaced with phosphoric acid.

### Example 5

This example provides a preparation method for an iron-nickel magnetic powder core material, which differs from Example 1 only in that an addition amount of the potassium silicate was 0.1% of a mass of the iron-nickel powder.

### Example 6

This example provides a preparation method for an iron-nickel magnetic powder core material, which differs from Example 1 only in that an addition amount of the potassium silicate was 1% of a mass of the iron-nickel powder.

### Example 7

This example provides a preparation method for an iron-nickel magnetic powder core material, which differs from Example 1 only in that a particle size of the iron-nickel powder was 10-15 μm.

### Example 8

This example provides a preparation method for an iron-nickel magnetic powder core material, which differs from Example 1 only in that a particle size of the iron-nickel powder was 70-80 μm.

### Example 9

This example provides a preparation method for an iron-nickel magnetic powder core material, which differs from Example 1 only in that the methyl chlorosilane was replaced with kaolin.

### Comparative Example 1

This comparative example provides a preparation method for an iron-nickel magnetic powder core material, which differs from Example 1 only in that the aqueous solution of potassium silicate was replaced with an acetone solution of phosphoric acid, and an addition amount of the phosphoric acid was 0.3% of a mass of the primary passivated iron-nickel powder.

### Comparative Example 2

This comparative example provides a preparation method for an iron-nickel magnetic powder core material, which differs from Example 1 only in that step (1) was not performed, i.e., the preparation method comprises:
(1) iron-nickel powder with a particle size of 25-38 μm and an aqueous solution of potassium silicate were mixed and stirred for a coating treatment, and then dried to obtain passivated iron-nickel powder;
an addition amount of the potassium silicate was 0.3% of a mass of the iron-nickel powder; and
(2) the passivated iron-nickel powder obtained in step (1) and methyl chlorosilane were mixed and stirred, and then subjected to granulation where a particle size was 250-270 μm after the granulation, and then baked at 160° C. for 90 min, then added with magnesium stearate, and then subjected to sieving where a particle size was 250-270 μm after the sieving, and pressed at 19 T/cm² to obtain the iron-nickel magnetic powder core material;
an addition amount of the methyl chlorosilane was 1% of a mass of the passivated iron-nickel powder; an addition amount of the magnesium stearate was 0.3% of a mass of the passivated iron powder.

### Comparative Example 3

This comparative example provides a preparation method for an iron-nickel magnetic powder core material, which differs from Example 1 only in that step (2) was not performed, i.e., the preparation method comprises:
(1) iron-nickel powder with a particle size of 25-38 μm and an organosilicon resin were mixed and stirred for a coating treatment, and then dried, and annealed at 900° C. to obtain passivated iron-nickel powder;
an addition amount of the organosilicon resin was 0.4% of a mass of the iron-nickel powder; and
(2) the passivated iron-nickel powder obtained in step (1) and methyl chlorosilane were mixed and stirred, and then subjected to granulation where a particle size was 250-270 μm after the granulation, and then baked at 160° C. for 90 min, then added with magnesium stearate, and then subjected to sieving where a particle size was 250-270 μm after the sieving, and pressed at 19 T/cm² to obtain the iron-nickel magnetic powder core material;
an addition amount of the methyl chlorosilane was 1% of a mass of the passivated iron-nickel powder; an addition amount of the magnesium stearate was 0.3% of a mass of the passivated iron powder.

The iron-nickel magnetic powder core material in Examples 1-9 and Comparative Examples 1-3 was manufactured into standard rings with an outer diameter of 12.7 mm, an inner diameter of 7.62 mm, and a height of 4.75 mm.

Under a frequency of 16 kHz, a voltage of 0.3 V, and coil turns of 27 Ts, the inductances of the standard rings in Examples 1-9 and Comparative Examples 1-3 and the commercially available iron-nickel alloy magnetic powder core standard ring were measured at currents of 0 A, 3.3, 5.1, 6.9, and 8.7, which were recorded as L0, L3.3, L5.1, L6.9, and L8.7, respectively, and the saturation characteristic of the magnetic powder core material was characterized by the ratio of the inductance at different currents to L0, and the results are shown in Table 1.

TABLE 1

| | | 3.3 A | | 5.1 A | | 6.9 A | | 8.7 A | |
|---|---|---|---|---|---|---|---|---|---|
| | 0 A | | Saturation | | Saturation | | Saturation | | Saturation |
| | Inductance/ | Inductance/ | character- | Inductance/ | character- | Inductance/ | character- | Inductance/ | character- |
| | (μH) | (μH) | istic/% | (μH) | istic/% | (μH) | istic/% | (μH) | istic/% |
| Example 1 | 42.67 | 38.9 | 91.16 | 34.12 | 79.96 | 28.85 | 67.61 | 23.63 | 55.38 |
| Example 2 | 42.37 | 38.69 | 91.31 | 33.95 | 80.13 | 28.69 | 67.71 | 23.52 | 55.51 |
| Example 3 | 42.48 | 38.78 | 91.29 | 34.01 | 80.06 | 28.73 | 67.63 | 23.56 | 55.46 |
| Example 4 | 41.32 | 35.45 | 85.79 | 31.48 | 76.19 | 25.98 | 62.88 | 20.35 | 49.25 |
| Example 5 | 41.12 | 35.24 | 85.70 | 31.35 | 76.24 | 25.84 | 62.84 | 20.22 | 49.17 |
| Example 6 | 40.97 | 35.12 | 85.72 | 31.17 | 76.08 | 25.76 | 62.88 | 20.12 | 49.11 |
| Example 7 | 41.23 | 35.35 | 85.74 | 31.45 | 76.28 | 25.89 | 62.79 | 20.32 | 49.28 |
| Example 8 | 41.17 | 35.27 | 85.67 | 31.38 | 76.22 | 25.79 | 62.64 | 20.28 | 49.26 |
| Example 9 | 41.31 | 35.44 | 85.79 | 31.45 | 76.13 | 25.92 | 62.75 | 20.32 | 49.19 |
| Comparative | 40.44 | 35.56 | 87.93 | 30.45 | 75.30 | 24.18 | 59.79 | 18.53 | 45.82 |
| Examples 1 | | | | | | | | | |
| Comparative | 41.34 | 36.17 | 87.49 | 31.21 | 75.50 | 24.76 | 59.89 | 18.97 | 45.89 |
| Examples 2 | | | | | | | | | |
| Comparative | 40.59 | 35.57 | 87.63 | 30.78 | 75.83 | 24.30 | 59.87 | 18.56 | 45.73 |
| Examples 3 | | | | | | | | | |
| Commercial | 41.05 | 35.23 | 85.82 | 31.28 | 76.20 | 25.85 | 62.97 | 20.23 | 49.28 |
| product | | | | | | | | | |

The following can be seen from Table 1:
(1) It can be seen from the data of Examples 1-9 that the iron-nickel magnetic powder core material obtained by the preparation method provided in the present application has L0≥42.37 μH, L3.3≥38.69 μH, L5.1≥34.01 μH, L6.9≥28.73 μH, and L8.7≥23.63 μH under the preferred conditions; the ratio of inductance to L0 decays slowly under different currents, and under preferred conditions, the saturation characteristic at 3.3 A is ≥91.16%, the saturation characteristic at 5.1 A is ≥79.96%, the saturation characteristic at 6.9 A is ≥67.61%, and the saturation characteristic at 8.7 A is ≥55.46%.
(2) As can be seen from a comprehensive comparison of the data of Example 1, Example 4, and Comparative Example 1, the difference between Example 4 and Example 1 is only that potassium silicate is replaced with phosphoric acid, and the difference between Comparative Example 1 and Example 1 is only that an aqueous solution of potassium silicate is replaced with an acetone solution of phosphoric acid, and the inductance and saturation characteristic at each current in Example 1 are all significantly higher than those in Example 4 and Comparative Example 1. It can be seen that in the present application, by controlling the use of an aqueous solution of inorganic coating agent and by controlling the type of inorganic coating agent, the inductance and saturation characteristic of the iron-nickel magnetic powder core material can be improved.
(3) As can be seen from a comprehensive comparison of the data of Example 1 and Examples 5-6, the addition amount of potassium silicate in Example 1 is 0.3% of the mass of the iron-nickel powder, and compared to where the addition amounts are 0.1% and 1% in Example 5 and Example 6, respectively, the inductance and saturation characteristic at each current in Example 1 are all significantly higher than those of Example 5 and Example 6. It can be seen that the addition amount of the inorganic coating agent is preferably controlled in the present application to improve the inductance and saturation characteristic of the iron-nickel magnetic powder core material.
(4) As can be seen from a comprehensive comparison of the data of Example 1 and Examples 7-8, the particle size of the iron-nickel powder in Example 1 is 25-38 μm, and compared to where the particle sizes are 10-15 μm and 70-80 μm in Example 7 and Example 8, respectively, the inductance and saturation characteristic at each current in Example 1 are all significantly higher than those of Example 7 and Example 8. It can be seen that the particle size of the iron-nickel powder is preferably controlled in the present application to improve the inductance and saturation characteristic of the iron-nickel magnetic powder core material.
(5) As can be seen from a comprehensive comparison of the data of Example 1 and Example 9, the difference between Example 9 and Example 1 is only that the methyl chlorosilane is replaced with kaolin, and the inductance and saturation characteristic at each current of Example 1 are all significantly higher than those of Example 9. It can be seen that the type of the binder is preferably controlled in the present application to improve the inductance and saturation characteristic of the iron-nickel magnetic powder core material.
(6) As can be seen from a comprehensive comparison of the data of Example 1 and Comparative Examples 2-3, the difference between Comparative Example 2 and Example 1 is only that step (1) is not performed, and the difference between Comparative Example 3 and Example 1 is only that step (2) is not performed, and the inductance and saturation characteristic at each current of Example 1 are all significantly higher than those of Comparative Examples 2-3. It can be seen that in the present application, by sequentially performing the primary coating treatment and the secondary coating treatment, the inductance and saturation characteristic of the iron-nickel magnetic powder core material can be improved.

In summary, the preparation method for the iron-nickel magnetic powder core material provided in the present application can effectively improve the inductance and saturation characteristic of the iron-nickel magnetic powder core material.

The applicant declares that the above are only specific embodiments of the present application, but the protection scope of the present application is not limited thereto. It should be understood by those skilled in the art that any changes or substitutions which can be easily thought of by those skilled in the art in the technical scope disclosed by the present application shall fall within the protection scope and disclosure scope of the present application.

1. A preparation method for an iron-nickel magnetic powder core material, which comprises the following steps:
(1) mixing iron-nickel powder and an organic coating agent for a primary coating treatment, and then sequentially performing drying and annealing to obtain primary passivated iron-nickel powder;
(2) mixing the primary passivated iron-nickel powder obtained in step (1) and an aqueous solution of an inorganic coating agent for a secondary coating treatment, and then drying to obtain secondary passivated iron-nickel powder; and
(3) mixing the secondary passivated iron-nickel powder obtained in step (2) and a binder, and then sequentially performing granulation, baking, and pressing to obtain the iron-nickel magnetic powder core material.

2. The preparation method according to claim 1, wherein a particle size of the iron-nickel powder in step (1) is 25-38 μm.

3. The preparation method according to claim 1, wherein a mass percentage of nickel in the iron-nickel powder is 49-51%.

4. The preparation method according to claim 1, wherein the organic coating agent comprises any one or a combination of at least two of an organosilicon resin, a silane coupling agent or a phenolic resin.

5. The preparation method according to claim 1, wherein an addition amount of the organic coating agent is 0.3-0.5% of a mass of the iron-nickel powder;
preferably, the mixing in step (1) is performed with stirring.

6. The preparation method according to claim 1, wherein the annealing in step (1) is performed at a temperature of 880-920° C.

7. The preparation method according to claim 1, wherein the inorganic coating agent in step (2) comprises any one or a combination of at least two of aluminum phosphate, glass powder or potassium silicate;
preferably, the mixing in step (2) is performed with stirring.

8. The preparation method according to claim 1, wherein after the drying in step (2), sieving is performed to obtain the secondary passivated iron-nickel powder.

9. The preparation method according to claim 1, wherein the binder in step (3) comprises any one or a combination of at least two of a specialty silane monomer, silica sol, a silane coupling agent or polyvinyl butyral;
preferably, the mixing in step (3) is performed with stirring.

10. The preparation method according to claim 1, wherein after the granulation in step (3), a particle size is 250-270 μm.

11. The preparation method according to claim 1, wherein after the baking in step (3), a lubricant is added, then sieving is performed, and then the pressing is performed.

12. The preparation method according to claim 1, wherein a pressure of the pressing in step (3) is 17-20 T/cm².

13. The preparation method according to claim 1, wherein the preparation method comprises the following steps:
(1) mixing and stirring iron-nickel powder with a particle size of 25-38 μm and an organic coating agent for a primary coating treatment, and then performing drying, and annealing at 880-920° C. to obtain primary passivated iron-nickel powder;
an addition amount of the organic coating agent is 0.3-0.5% of a mass of the iron-nickel powder, and the organic coating agent comprises any one or a combination of at least two of an organosilicon resin, a silane coupling agent or a phenolic resin;
(2) mixing and stirring the primary passivated iron-nickel powder obtained in step (1) and an aqueous solution of an inorganic coating agent for a secondary coating treatment, and then sequentially drying and sieving to obtain secondary passivated iron-nickel powder with a particle size of 120-150 μm;
an addition amount of the inorganic coating agent is 0.1-0.5% of a mass of the primary passivated iron-nickel powder, and the inorganic coating agent comprises any one or a combination of at least two of aluminum phosphate, glass powder or potassium silicate; and
(3) mixing and stirring the secondary passivated iron-nickel powder obtained in step (2) and a binder, and then performing granulation, wherein a particle size after the granulation is 250-270 μm, and then baking at 150-170° C. for 80-100 min, then adding a lubricant, and then sieving, wherein a particle size after the sieving is 250-270 μm, and then pressing at 17-20 T/cm² to obtain the iron-nickel magnetic powder core material;
an addition amount of the binder is 0.1-2% of a mass of the secondary passivated iron-nickel powder, and the binder comprises any one or a combination of at least two of a specialty silane monomer, silica sol, a silane coupling agent or polyvinyl butyral; an addition amount of the lubricant is 0.2-0.5% of a mass of the secondary passivated iron-nickel powder, and the lubricant comprises any one or a combination of at least two of polypentaerythritol, polyethylene wax, magnesium stearate, hydrous magnesium silicate or a polyester resin.

14. The preparation method according to claim 1, wherein an addition amount of the inorganic coating agent is 0.1-0.5% of a mass of the primary passivated iron-nickel powder.

15. The preparation method according to claim 8, wherein the secondary passivated iron-nickel powder obtained by the sieving in step (2) has a particle size of 120-150 μm.

16. The preparation method according to claim 1, wherein an addition amount of the binder is 0.1-2% of a mass of the secondary passivated iron-nickel powder.

17. The preparation method according to claim 1, wherein the baking is performed at a temperature of 150-170° C.; preferably, the baking is performed for a period of 80-100 min.

18. The preparation method according to claim 11, wherein the lubricant comprises any one or a combination of at least two of polypentaerythritol, polyethylene wax, magnesium stearate, hydrous magnesium silicate or a polyester resin.

19. The preparation method according to claim 11, wherein an addition amount of the lubricant is 0.2-0.5% of a mass of the secondary passivated iron-nickel powder.

20. The preparation method according to claim 11, wherein after the sieving in step (3), a particle size is 250-270 μm.
